(19) United States
(12) Patent Application Publication
(10) Pub. No.: US 2026/0333258 A1
(43) Pub. Date: Oct. 22, 2026

(54) SYNCHRONIZATION SIGNAL BLOCK (SSB) RASTERS DEFINITION FOR MULTI-RADIO ACCESS TECHNOLOGY (RAT) SPECTRUM SHARING (MRSS)

(71) Applicant: Lenovo (United States) Inc., Morrisville, NC (US)

(72) Inventors: Karthikeyan Ganesan, Nauheim (DE); Ali Ramadan Ali, Kraiburg am Inn (DE); Ravi Kuchibhotla, Chicago, IL (US); Colin Frank, Park Ridge, IL (US)

(73) Assignee: Lenovo (United States) Inc., Morrisville, NC (US)

(21) Appl. No.: 19/327,920

(22) Filed: Sep. 12, 2025

(51) Int. Cl. H04W 56/00

(52) U.S. Cl. CPC H04W 56/0015; H04W 56/0035

(57) ABSTRACT

Various aspects of the present disclosure relate to synchronization signal block (SSB) rasters definition for multi-radio access technology (RAT) spectrum sharing (MRSS). An apparatus, such as a user equipment (UE), receives a signal over one or more radio frequencies. The apparatus processes the signal to identify a RAT associated with the signal, where the RAT is identified based at least in part on a synchronization raster frequency offset of a first RAT relative to a second RAT.

### TECHNICAL FIELD

The present disclosure relates to wireless communications, and more specifically to synchronization signal block (SSB) transmission in wireless communications systems.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The devices (e.g., NE, UE), processors, and methods of the present disclosure each have several innovative aspects, no single one of which is solely responsible for the desirable features disclosed herein.

An apparatus (e.g., UE, NE) for wireless communication is described. The apparatus may be configured to, capable of, or operable to perform one or more operations as described herein. For example, the apparatus may be configured to, capable of, or operable to transmit a signal over one or more radio frequencies, where the signal is generated based at least in part on a synchronization raster frequency offset of a first radio access technology (RAT) relative to a second RAT.

A processor (e.g., a standalone processor chipset, or a component of a UE, NE) for wireless communication is described. The processor may be configured to, capable of, or operable to perform one or more operations as described herein. For example, the processor may be configured to, capable of, or operable to transmit a signal over one or more radio frequencies, where the signal is generated based at least in part on a synchronization raster frequency offset of a first RAT relative to a second RAT.

A method performed or performable by an apparatus for wireless communication is described. The method may include transmitting a signal over one or more radio frequencies, where the signal is generated based at least in part on a synchronization raster frequency offset of a first RAT relative to a second RAT.

In some implementations, the processor, and the method described herein, may detect the first RAT by coarsely tuning a radio frequency (RF) to match a RF of the first RAT.

In some implementations, the synchronization rasters of the first RAT may interleave with synchronization rasters of the second RAT, and synchronization rasters of the first RAT may align with channel rasters.

In some implementations of the apparatus, the synchronization rasters of the first RAT may be centered with SSBs inside channel bandwidths. The channel bandwidths may be spaced based at least in part on a 100 kilohertz (kHz) spacing, and include a valid synchronization raster satisfying a predetermined condition.

In one example, a frequency carrier center of the first RAT may be less than or equal to 0.45 megahertz (MHz) from a frequency of the synchronization rasters of the second RAT.

In another example, the synchronization raster frequency offset may include one or more of a large raster shift, a small raster shift, or a constant offset.

In some implementations, the constant offset may include a predefined offset from the first RAT and the synchronization rasters of the first RAT and the second RAT are interlaced. The large raster shift and the small raster shift may be multipliers from the second RAT.

In some implementations of the apparatus, the processor, and the method described herein, the apparatus, the processor, and the method may further be configured to, capable of, operable to, performed to, or performable to transmit a signal over one or more radio frequencies, wherein the signal is generated based at least in part on a synchronization raster frequency offset of a first RAT relative to a second RAT.

An apparatus (e.g., UE, NE) for wireless communication is described. The apparatus may be configured to, capable of, or operable to perform one or more operations as described herein. For example, the apparatus may be configured to, capable of, or operable to receive a signal over one or more radio frequencies, and process the signal to identify a RAT associated with the signal, where the RAT is identified based at least in part on a synchronization raster frequency offset of a first RAT relative to a second RAT.

A processor (e.g., a standalone processor chipset, or a component of a NE or UE) for wireless communication is described. The processor may be configured to, capable of, or operable to perform one or more operations as described herein. For example, the processor may be configured to, capable of, or operable to receive a signal over one or more radio frequencies, and process the signal to identify a RAT associated with the signal, where the RAT is identified based at least in part on a synchronization raster frequency offset of a first RAT relative to a second RAT.

A method performed or performable by an apparatus (e.g., UE, NE) for wireless communication is described. The method may include receiving a signal over one or more radio frequencies, and processing the signal to identify a RAT associated with the signal, where the RAT is identified based at least in part on a synchronization raster frequency offset of a first RAT relative to a second RAT.

In some implementations of the apparatus (e.g., UE, NE), the processor, and the method described herein, may detect the first RAT by coarsely tuning a RF to match a RF of the first RAT.

In some implementations, the synchronization rasters of the first RAT may interleave with synchronization rasters of the second RAT, and synchronization rasters of the first RAT may align with channel rasters.

In some implementations of the apparatus (e.g., UE, NE), the synchronization rasters of the first RAT may be centered with SSBs inside channel bandwidths. The channel bandwidths may be spaced based at least in part on a 100 kilohertz (kHz) spacing, and include a valid synchronization raster satisfying a predetermined condition.

In one example, a frequency carrier center of the first RAT may be less than or equal to 0.45 megahertz (MHz) from a frequency of the synchronization rasters of the second RAT.

In another example, the synchronization raster frequency offset may include one or more of a large raster shift, a small raster shift, or a constant offset.

In some implementations, the constant offset may include a predefined offset from the first RAT and the synchronization rasters of the first RAT and the second RAT are interlaced. The large raster shift and the small raster shift may be multipliers from the second RAT.

In some implementations of the apparatus (e.g., UE, NE), the processor, and the method described herein, the apparatus, the processor, and the method may further be configured to, capable of, operable to, performed to, or performable to transmit a signal over one or more radio frequencies, wherein the signal is generated based at least in part on a synchronization raster frequency offset of a first RAT relative to a second RAT.

In some implementations of the apparatus (e.g., UE, NE), the processor, and the method described herein, the apparatus, the processor, and the method may further be configured to, capable of, operable to, performed to, or performable to.

### BRIEF DESCRIPTION OF THE DRAWINGS

FIG. 1 illustrates an example of a wireless communications system in accordance with aspects of the present disclosure.

FIG. 2 illustrates time and frequency structure of an SS/PBCH block.

FIGS. 3 and 4 illustrate an example for the timing of candidate SS/PBCH blocks within a SS burst set.

FIG. 5 illustrates an example of 5G synchronization rasters and 5G sync signal within channel BW of 5 MHz of N1 band, in accordance with aspects of the present disclosure.

FIG. 6 illustrates an example of 6G synchronization rasters with an offset from 5G synchronization rasters in accordance with aspects of the present disclosure.

FIG. 7 illustrates an example of frequency domain overlapping of 5G and 6G sync signal, in accordance with aspects of the present disclosure.

FIG. 8 illustrates an example of mapping of time domain 5G and 6G Sync signals, in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of an NE in accordance with aspects of the present disclosure.

FIG. 12 illustrates a flowchart of a method performed by a UE in accordance with aspects of the present disclosure.

FIG. 13 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. New radio (NR) SSB burst size is 5 ms, half frame, and transmitted either in the first half or second half of a radio frame which is indicated in master information block (MIB) and the default SSB periodicity is 20 ms for UE performing initial access while the actual periodicity of SSBs is indicated in SIB1. A UE, NE or both may calculate a maximum number of candidate SSB transmissions in NR based on the frequency range and subcarrier spacings. The maximum number of candidate SSB for FR1 is 8 while for FR2 is 64.

In some examples, primary synchronization signal (PSS), secondary synchronization signal (SSS) and physical broadcast channel (PBCH). PSS, SSS, and PBCH may be transmitted together in consecutive orthogonal frequency division multiplexing (OFDM) symbols. Each SSB occupies 4 OFDM symbols in the time domain and spread over 240 subcarriers (20 RBs) in the frequency domain. PSS occupies first OFDM symbol and span over 127 subcarriers. SSS is located in the third OFDM symbol and span over 127 subcarriers. There are 8 un-used subcarriers below SSS and 9 un-used subcarriers above SSS. PBCH occupies two full OFDM symbols (second and fourth) spanning 240 subcarriers and in the third OFDM symbol spanning 48 subcarriers below and above SSS. This results in PBCH occupying 576 subcarriers across three OFDM symbols (240+48+48+240=576).

In some instances, CORESET #0, which includes the scheduling information for SIB1, may be transmitted with 20 ms periodicity, which is the default periodicity of SIB1. There can be three ways to identify RAT in case of MRSS. One way is to define a distinct synchronization raster point in the frequency domain and/or time domain. A synchronization raster may represent specific frequency positions where a UE can expect to find the SSB, which includes the PSS, SSS, and PBCH. Another way is to define orthogonal sequences compared to the NR synchronization signals. A third way is to define explicit RAT identification in one of the remaining minimum system information (RMSI). One or more aspects of the present disclosure provides for a new raster is to be defined for 6G such that these rasters are distinct from 5G rasters, sufficiently separately and within the 5 MHz channel bandwidth.

Aspects of the present disclosure are described in the context of a wireless communications system.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

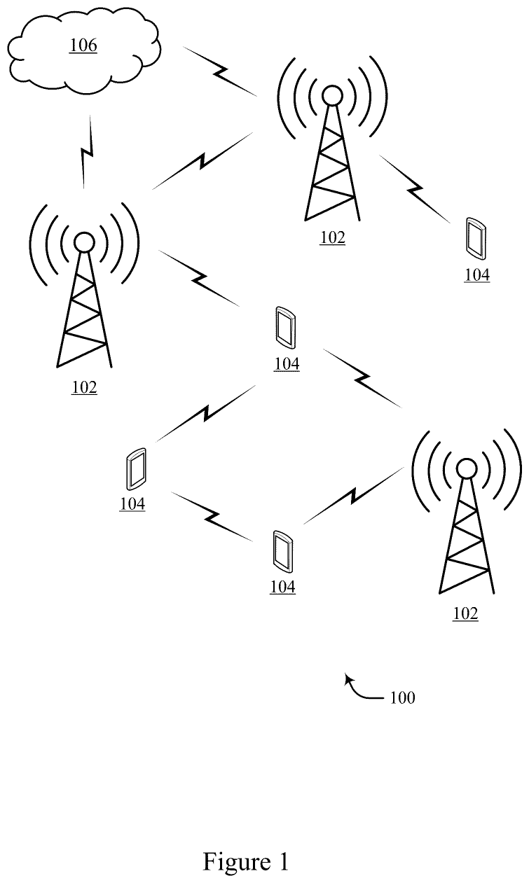

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, an apparatus (e.g., NE 102, UE 104) receives a signal over one or more radio frequencies, and processes the signal to identify a RAT associated with the signal, where the RAT is identified based at least in part on a synchronization raster frequency offset of a first RAT relative to a second RAT. An apparatus (e.g., NE 102, UE 104) communicates by transmitting a signal over one or more radio frequencies, wherein the signal is generated based at least in part on a synchronization raster frequency offset of a first RAT relative to a second RAT.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

A synchronization raster may indicate the frequency positions of the synchronization block that can be used by a UE for system acquisition when explicit signaling of the synchronization block position is not present. A global synchronization raster may be defined for multiple frequencies. The frequency position of the SS block may be defined as SS_{ref} with corresponding number Global Synchronization Channel Number (GSCN). Example parameters defining the SS_{ref} and GSCN for frequency ranges are specified in Table 1 for above 3 MHz channel bandwidth and in Table 2 for 3 MHz channel bandwidth. For band n100, additional parameters defining the SS_{ref} and GSCN are specified in Table 3. The resource element corresponding to the SS block reference frequency SS_{ref} is given. The synchronization raster and the subcarrier spacing of the synchronization block is defined separately for each band. The synchronization raster and the corresponding SS block do not cover all possible RF channel bandwidths and locations on Enhanced channel raster.

TABLE 1

| | SS Block frequency position | | Range |
|---|---|---|---|
| Frequency range | SS_{REF} | GSCN | of GSCN |
| 0-3000 MHz | N * 1200 kHz + M * 50 kHz, | 3N + (M − 3)/2 | 2²-7498 |
| | N = 1:2499, M ∈ {1, 3, 5} ¹ | | |
| 3000-24250 MHz | 3000 MHz + N * 1.44 MHz | 7499 + N | 7499-22255 |
| | N = 0:14756 | | |

NOTE
¹ The default value for operating bands with which only support SCS spaced channel raster(s) is M = 3.
NOTE
²GSCN = 2 (corresponding to ARFCN − ValueNR = 250) is a reserved value paired with reserved operating band n200.

Table 2 presents a summary of GSCN parameters for the global frequency for 3 MHz channel bandwidth.

TABLE 2

| Range of | | | |
|---|---|---|---|
| frequencies | SS block frequency position | | Range |
| (MHz) | SS_{REF} | GSCN | of GSCN |
| 0-1000, | N * 600 kHz + M * 50 kHz + | 26638 + 3N + | 26640-31634, |
| 1432-1435 | 300 kHz, | (M − 3)/2 | 33802-33804 |
| | N = 1:1665, M ∈ {1, 3, 5}, | | |
| | N = 2388, M ∈ {3, 5} or | | |
| | N = 2389, M ∈ {1} | | |
| | (Note 1) | | |

(NOTE 1):
Only applicable for 15 physical resource block (PRB) transmission bandwidth configuration within 3 MHz channel bandwidth with punctured PBCH defined in TS 38.211 [6] clause 7.4.3.1.
NOTE 2:
SCell with 15 PRB transmission bandwidth configuration within 3 MHz channel bandwidth will be configured only with SS Block frequency positions defined in this table.

Table 3 presents Additional GSCN parameters for band n100.

TABLE 3

| SS Block frequency | | |
|---|---|---|
| position SS_{REF} | | |
| (MHz) | GSCN | Note |
| 920.73 | 41637 | Only applicable for 12 PRB transmission bandwidth |
| | | configuration within 3 MHz channel (with 15 PRB |
| | | maximum transmission bandwidth configuration) with |
| | | punctured PBCH defined in TS 38.211 [6] clause |
| | | 7.4.3.1. |
| 921.45 | 41638 | Only applicable for 20 PRB transmission bandwidth |
| | | configuration within 5 MHz channel (with 25 PRB |
| | | maximum transmission bandwidth configuration) with |
| | | unpunctured PBCH defined in TS 38.211 [6] clause |
| | | 7.4.3.1. |

NOTE 1:
SCell with 12 PRB transmission bandwidth configuration within 3 MHz channel bandwidth or 20 PRB transmission bandwidth configuration within 5 MHz channel bandwidth will be configured only in band n100 and only with SS Block frequency positions defined in this table.

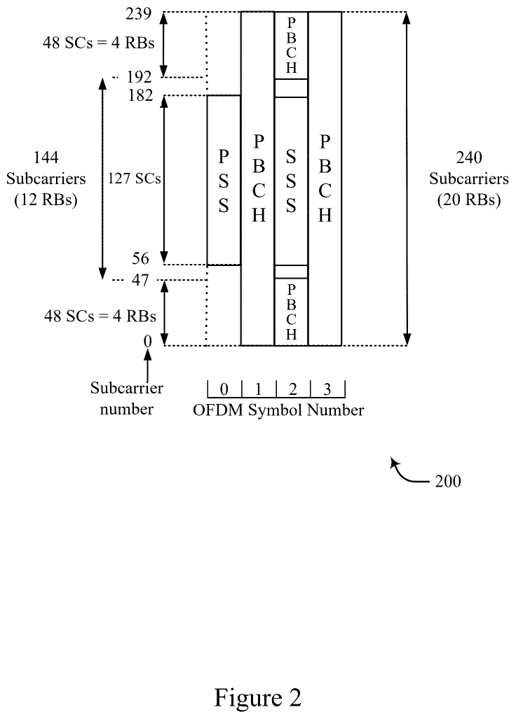

FIG. 2 illustrates a time and frequency structure 200 of an SS/PBCH block. In the time and frequency structure 200, PSS, SSS and PBCH are together in consecutive OFDM symbols and each SS/PBCH block occupies 4 OFDM symbols in the time domain and spread over 240 subcarriers (20 RBs) in the frequency domain. Further, PSS occupies the first OFDM symbol and span over 127 subcarriers, and SSS is located in the third OFDM symbol and span over 127 subcarriers. There are 8 unused subcarriers below SSS and 9 unused subcarriers above SSS. PBCH occupies two full OFDM symbols (second and fourth) spanning 240 subcarriers and in the third OFDM symbol spanning 48 subcarriers below and above SSS. This results in PBCH occupying 576 subcarriers across three OFDM symbols (240+48+48+240=576). PBCH demodulation reference signal (DM-RS) occupies 144 REs which is one-fourth of total REs and remaining for PBCH payload (576−144=432 REs).

Table 4 below presents a summary of frequency resources occupied by SS/PBCH block, including PSS, SSS, PBCH and DM-RS for PBCH. The complex-valued symbols corresponding to resource elements denoted as ‘Set to 0’ in Table 4 are set to zero. As can be seen from Table 4, the location of PBCH DM-RS depends upon PCID (v=NIDcell mod 4) of the cell, e.g., PCID already determined by the apparatus (e.g., UE, NE) using PSS/SSS.

Regarding SSB details in time domain, each SS/PBCH block spans across 4 OFDM symbols in the time domain and an SS/PBCH block is periodically transmitted with a periodicity of 5 ms, 10 ms, 20 ms, 40 ms, 80 ms or 160 ms. While longer SS/PBCH block periodicities enhances network energy performance, the shorter periodicities facilitate faster cell search for apparatuses (e.g., UE, NE). An apparatuses (e.g., UE, NE) can assume a default periodicity of 20 ms during initial cell search or idle mode mobility.

Regarding a SS burst set, to enable beam-sweeping for PSS/SSS and PBCH, SS burst sets are defined. An SS burst set includes a set of SS/PBCH block, and each SS/PBCH block can be transmitted on a different beam. Further, a SS burst set can include one or more SS/PBCH blocks. SS/PBCH blocks in the SS burst set are transmitted in time-division multiplexing fashion and an SS burst set can be confined to a 5 ms window and is either located in a first half or in a second half of a 10 ms radio frame. The network sets the SS/PBCH block periodicity via RRC parameter ssb-PeriodicityServingCell which can take values in the range {5 ms, 10 ms, 20 ms, 40 ms, 80 ms, 160 ms}.

Within a 5 ms half frame, the starting OFDM symbol index for a candidate SS/PBCH block within SS burst set depends upon subcarrier spacing (SCS) and carrier frequency/band summarized in Table 4 below. Table 4 presents an illustration of SSB design for different frequency range and subcarrier spacings.

TABLE 4

| | OFDM starting | | 3 GHz < f_{c} ≤ 6 | |
|---|---|---|---|---|
| | symbols of the | f_{c} ≤ 3 GHz | GHz | f_{c >} 6 GHz |
| SCS | candidate SSBs | Lₘₐₓ = 4 | Lₘₐₓ = 8 | Lₘₐₓ = 4 |
| Case A: | {2, 8} + 14n | n = 0, 1 | n = 0, 1, 2, 3 | NA |
| 15 kHz | | {2, 8, 16, 22} | {2, 8, 16, 22, 30, | |
| | | | 36, 44, 50} | |
| Case B: | {4, 8, 16, | n = 0 | n = 0, 1 | NA |
| 30 kHz | 20} + 28n | {4, 8, 16, 20} | {4, 8, 16, 20, 32, | |
| | | | 36, 44, 48} | |
| Case C: | {2, 8} + 14n | n = 0, 1 | n = 0, 1, 2, 3 | NA |
| 30 kHz | | {2, 8, 16, 22} | {2, 8, 16, 22, 30, | |
| | | | 36, 44, 50} | |
| Case D: | {4, 8, 16, | NA | NA | n = 0, 1, 2, 3, 5, 6, |
| 120 kHz | 20} + 28n | | | 7, 8, 10, 11, 12, |
| | | | | 13, 15, 16, 17, 18 |
| | | | | {4, 8, 16, 20 . . . |
| | | | | 508, 512, 520, 524} |
| Case E: | {8, 12, 16, | NA | NA | n = 0, 1, 2, 3, 5, 6, |
| 240 kHz | 20, 32, 36, | | | 7, 8 |
| | 40, 44} + 56n | | | {8, 12, 16, 20 . . . |
| | | | | 480, 484, 488, 492} |

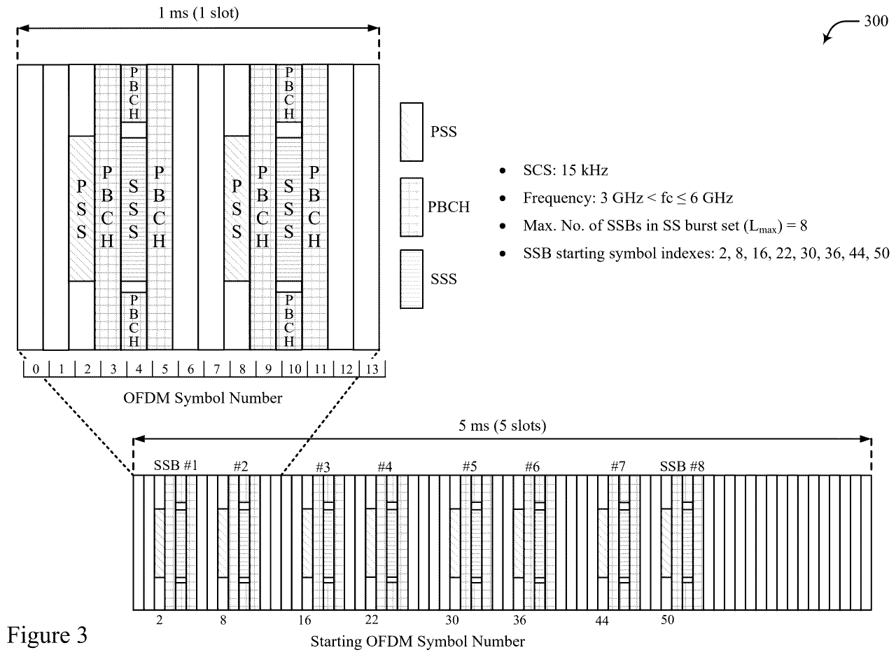

FIGS. 3 and 4 illustrate an example 300 for the timing of candidate SS/PBCH blocks within the SS burst set. The example 300, for instance, is for the case of SCS=15 kHz and carrier frequency between 3 GHz and 6 GHz.

The channel raster defines a subset of RF reference frequencies that can be used to identify the RF channel position in the uplink and downlink. The RF reference frequency for an RF channel maps to a resource element on the carrier. For each operating band, a subset of frequencies from the global frequency raster are applicable for that band and forms a channel raster with a granularity ΔF_{Raster}, which may be equal to or larger than ΔF_{Global}. The synchronization raster indicates the frequency positions of the synchronization block that can be used by the UE for system acquisition when explicit signaling of the synchronization block position is not present.

A global synchronization raster is defined for all frequencies. The frequency position of the SS block is defined as SS_{REF} with corresponding number GSCN. The parameters defining the SS_{REF} and GSCN for all the frequency ranges are in Table 1 for above 3 MHz channel bandwidth and in Table 2 for 3 MHz channel bandwidth. Synchronization raster is the center frequency of the SSB block bandwidth e.g., if the SSB bandwidth is 20 PRBs, then raster implies SC #0 of RB #10.

Multiple RATs may coexist in case of legacy frequency bands such as less than 3 GHz of frequency range and multi-RAT spectrum sharing can be used for the purpose of sharing spectrum between 4G, 5G and 6G in these bands. The channel rasters in these spectrum is 100 kHz i.e., which is not aligned with subcarrier spacing of 2μ*15 kHz, μ=0 or aligned with 2μ*15 kHz, μ=0 depending on the region and frequency band.

One of the main problems to address in the multi-RAT coexistence using MRSS is defining distinct/non-overlapping synchronization raster and alignment with all channel rasters meaning there should be at least one synchronization rasters for every channel rasters. Another condition is that the synchronization block bandwidth is within the minimum system bandwidth/transmission bandwidth is these frequency range.

In at least one implementation, a synchronization raster offset is defined for 6G from 5G synchronization rasters formula such that the 6G synchronization rasters can be interleaves the 5G synch rasters without overlapping and aligned with channel rasters. The chosen synchronization rasters must cover 5 MHz grid centers with SSBs inside channel BW/Transmission BW with every 100 kHz channel start having a valid synchronization raster satisfying |f_sync-fcarrier_center|≤0.45 MHz. In one implementation, the synchronization rasters for 6G can be sufficiently spaced in the frequency domain relatively to that of 5G synchronization rasters so that a UE with free running oscillators at the time of initial cell search can coarsely tune its RF to that of 6G synchronization raster frequency, to detect the 6G synchronization signal. RF with free running oscillation has around +−10 PPM frequency error which translates to around 70 kHz of frequency error. 5G synchronization rasters is defined in terms of (N, M) combination, whereas N refers to the large raster shift in terms of 1.2 MHz and M=(1,3,5) refers to smaller shifts in terms of 100 kHz apart corresponding for every N value.

Therefore, the 6G synchronization rasters must have minimum relative spacing of around +−100 kHz from that of the 5G synchronization rasters for coarse detection and then the offsets cannot be equal to multiples of (M*50 kHz) to avoid overlapping. Hence, 0, 50, 150, 250 kHz can be avoided.

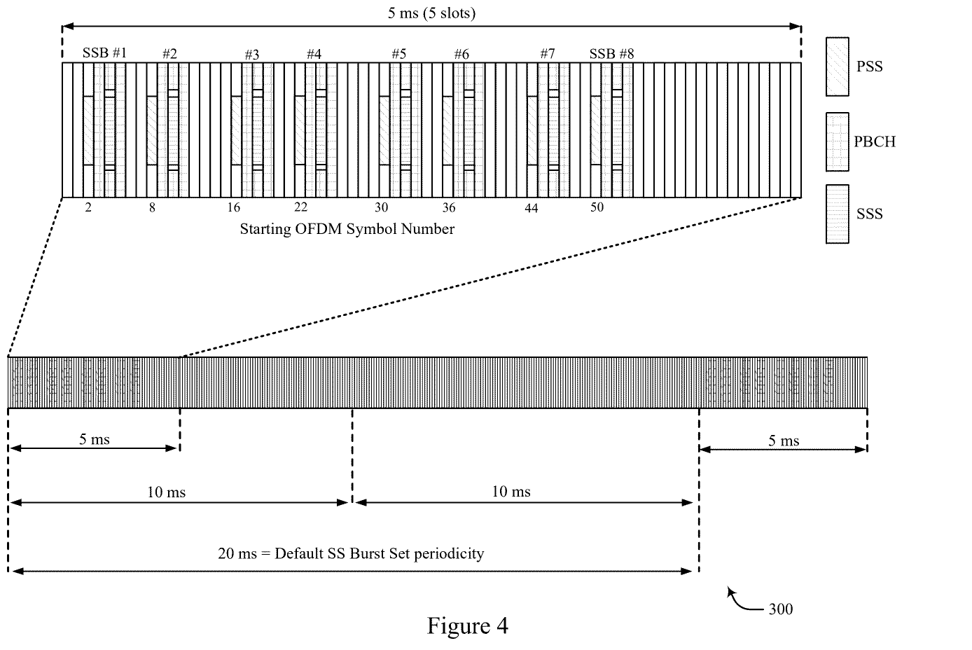

FIG. 5 illustrates an example of 5G synchronization rasters and 5G sync signal within channel bandwidth (BW) of 5 MHz of N1 band, in accordance with aspects of the present disclosure. In this example, 5G Synchronization raster can be defined as f₅=N×1200 kHz+M×50 kHz, where N∈[1, 2499], M∈{1, 3, 5}. This creates a raster grid every 1.2 MHz, with smaller offsets of 50, 150, 250 kHz. Considering N1 band for 5 MHz (2110-2115 MHz). N=1759=>2110.85, 2110.95, 2111.05 MHz. N=1760=>2112.05, 2112.15, 2112.25 MHz. N=1761=>2113.25, 2113.35, 2113.45 MHz. N=1762=>2114.45, 2114.55, 2114.65 MHz. N=1769 is within the transmission bandwidth of 4.5 MHz as shown in solid black color.

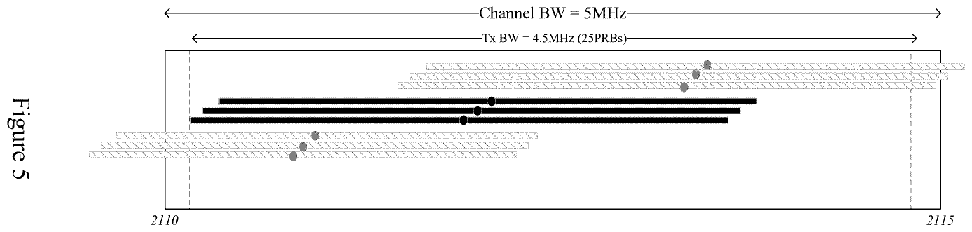

FIG. 6 illustrates an example of 6G synchronization rasters with an offset from 5G synchronization rasters in accordance with aspects of the present disclosure. In this example, a 6G synchronization rasters may be defined according to a 6G extended synchronization raster formula, which is an additional offset to the 5G formula. f₆=N×1200 kHz+M×50 kHz+Δf. Where Δf∈{300, 400, 500, 600, 700, 800, 900} kHz. Δf is chosen to ensure the 6G raster is distinct from the 5G raster. Further, the raster aligns with 5 MHz channel centers such that the SSB (3.6 MHz) fits within a 5 MHz transmission bandwidth (25 RBs@15 kHz SCS) satisfying |f_sync−fcarrier_center|≤0.45 MHz.

In this implementation, extend smaller shifts may be used for 6G synchronization rasters. The 6G raster can be defined by modifying the smaller shifts with incorporating additional offsets defined above with sufficient spacings and distinct (not overlapping) from the 5G rasters using base-step of 1200 and M*50, M={1,3,5} resulting in (50, 150, 250). Hence, smaller shifts can be M={7,9,11} resulting in (350, 450, 550) or otherwise smaller shifts can be selected such that is 100 kHz apart from each other similar to 5G and 100 kHz apart from 5G rasters too using these points {350, 400, 450, . . . , 1150} kHz something like {400, 700, 950} or {500, 800, 1100} or {350, 900, 1150}. In implementations, a higher offset leads to less numbers of frequency raster leading to power saving gains. The 5G rasters and 6G rasters can be interlaced.

In another implementation, change base step-a new (A, S) pair may be used for 6G synchronization rasters. Since the basestep in 5G is 1200, then the key quantity for finding a distinct 6G raster by changing both base step and small offsets with no additional constant offsets can be derived using: G=gcd(A, 1200), where G should be at least 600 which means that basestep can be 600, 1200. However, the smaller shift can be similar to the above implementation such that it can be defined from 350, 1150 kHz in multiples of 50 kHz, while keeping 100 kHz separation between them.

Different synchronization raster implementations are presented below. Table 5 presents an illustration of synchronization raster implementation options for different SSB BW for MRSS.

TABLE 5

| Synchronization raster | Conditions to evaluate | | |
|---|---|---|---|
| implementations | synchronization raster | 6G SSB BW = 20 PRBs | 6G SSB BW = 12 PRBs |
| 6G Extended | 1. Distinct / non-overlapping | Δf ∈ {300, 400, 500, | Δf ∈ {0, 300, 600, |
| Synchronization raster | synchronization raster | 600, 700, 800, 900} | 900, 1000} kHz |
| Formula: additional | 2. At least one synchronization rasters | kHz | |
| offset to the 5G formula | for every channel rasters | | |
| f₆ = N × 1200 | 3. synchronization block bandwidth is | | |
| kHz + M × 50 | within the minimum system bandwidth / | | |
| kHz + Δf | transmission bandwidth is these | | |
| | frequency range (\|f_sync − | | |
| | fcarrier_center\| ≤ 0.45 MHz in case | | |
| | SSB BW = 20 RBs and (\|f_sync − | | |
| | fcarrier_center\| ≤ 1.17 MHz in case | | |
| | SSB BW = 12 RBs) | | |
| | 4. Minimum relative spacing of around +− | | |
| | 100 kHz from that of the 5G | | |
| | synchronization rasters | | |
| Extend smaller shifts | Candidate Smaller shifts can be selected | Candidates to choose | Candidate S value |
| | such that: | from {350, 400, | shown below |
| | 1. 100 kHz from each other similar to 5G | 450, . . . , 1150} | |
| | 2. 100 kHz apart from 5G rasters too | kHz | |
| | 3. Other conditions from above | | |
| Change base step - a new | Distinct 6G raster by changing both base | A = 600 kHz, | A = 3000 kHz |
| (A, S) pair | step and small offsets with no additional | S = from above | with possible S = |
| | constant offsets while satisfying above | | (350, 1050, 1750) or |
| | conditions | | (450, 1750, 2750) or |
| | | | {550, 2150, 2850}) |
| | | | A = 2400 kHz |
| | | | with possible S = |
| | | | (400, 700, 950) |
| | | | A = 1800 kHz |
| | | | With possible S = |
| | | | (350, 450, 550) or |
| | | | {350, 1150, 1650} or |
| | | | {450, 950, 1750} or |
| | | | {550, 1050, 1550} |

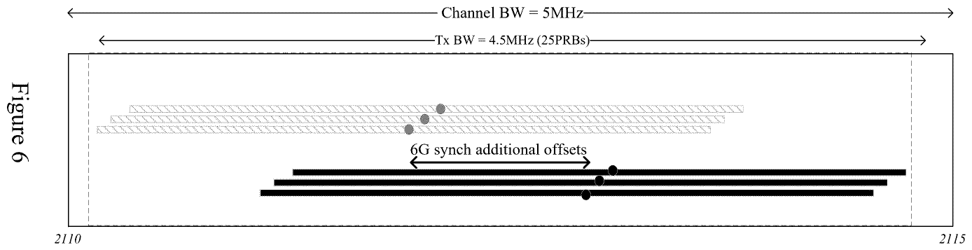

FIG. 7 illustrates an example of frequency domain overlapping of 5G and 6G sync signal in accordance with aspects of the present disclosure. In this example, although 6G synchronization rasters can be distinct and non-overlapping from 5G, 5G and 6G sync signals may overlap because SSB signal bandwidth is wider for example, 20 PRBs@15 kHz SCS. In case of MRSS, the interference between 5G and 6G sync signals can be handled by designing orthogonal synchronization signals generated using polynomials from preferred pairs and avoiding time domain overlap by having time domain offset between them.

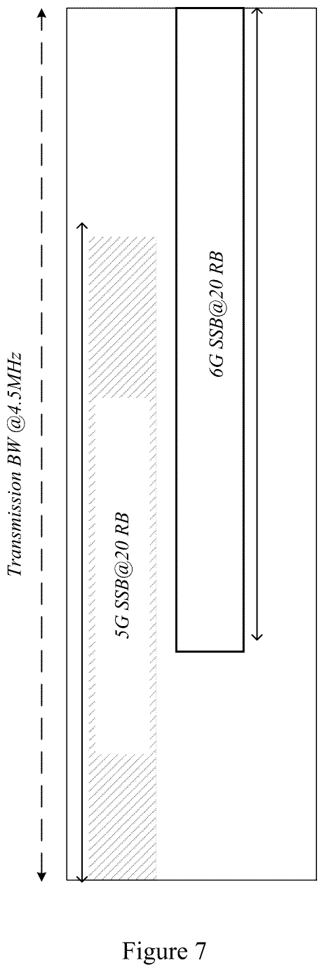

FIG. 8 illustrates an example of mapping of time domain 5G and 6G Sync signals, in accordance with aspects of the present disclosure. In case of MRSS, where both 5G and 6G synchronization signal are transmitted by a cell, cell may transmit 6G synchronization with a predefined offset from the 5G synchronization signal. The offset can be defined in terms of symbols or slots or half frame or radio frame. In one implementation, the 6G synchronization signal can be mapped starting in the end of the radio frame boundary or frame boundary.

In implementations, one or more synchronization rasters can be reserved to indicate a feature configured in a cell related to initial access such as UE monitoring on-demand common channel such as on-demand minimum state information (MSI) on a reserved synchronization raster after transmitting uplink wake up signal to wake up a dormant BS. Such reserved raster for feature indication can be configured for one or more frequency range. In another implementation, one or more predefined synchronization rasters in a frequency range can be reserved to transmit a periodic SS/PBCH block or part of SS/PBCH block meaning only synchronization signals or part of synchronization signals, e.g., PSS with long periodicity, or minimum system information (MSI), or a combination thereof. A UE may transmit uplink wake up signal request based on pre-configuration from a mobile network operator (MNO) and monitor these predefined synchronization rasters for on-demand information as discussed in the present disclosure. Such synch rasters may be for a cell or common for a group of cells.

In implementation, a UE may receive information about the uplink wake up signal configuration to request on-demand MSI or periodicity of MSI of a cell or a group of cells after decoding this information (e.g., SS/PBCH, part of SS/PBCH, MSI, or combinations thereof) from the information received in reserved synchronization raster. Hence, a UE may receive information such as type of transmission in this cell or a group of cells including SS/PBCH and/or MSI which can be on-demand or longer periodicity, and may also include uplink wake up signal configuration to request on-demand MSI or periodicity of MSI and/or one or more cell identifiers including time/frequency location of such signals to minimize the blind search for a cell or a group of cells. A UE may receive dormancy state (e.g., active with long periodicity or inactive in ultra deep sleep state with on-demand wake-up,) cell active transmission periods, reception periods, non-active transmission periods, reception periods, etc., of a cell or group of cells from information transmitted in a synchronization rasters. The UE may also receive information indicating whether presence of a SSB-less or MSI-less cell and its associated reference cell are to receive configuration related to reference timing based on SSB or reference MSI. In implementations, there can be a primary raster points at a predefined locations in a frequency range providing reference timing through SS/PBCH and reference MSI configuration including radio resource configuration commonly applicable for a group of cells. In implementations, MSI may include information about on-demand reference signal and dedicated MSI of one or more associated cells. Such dedicated MSI may include dedicated radio resource configuration for one or more associated cells.

In one example, UE during initial cell search may may first search for synchronization signals in one or more primary rasters, where primary rasters are sparser with few synchronization raster points in the frequency. In one option, one of the above conditions such as to have a synchronization block for every channel raster and/or having a synchronization block within a minimum carrier bandwidth of 3/5 MHz are not satisfied. If an apparatus (e.g., UE, NE) doesn't find synchronization signals in one of the primary rasters, the apparatus may scan the secondary rasters which maybe finer compared to the primary raster meaning more rasters in the frequency domain. In one option, secondary rasters can fulfill one of the above conditions such as to have a synchronization block for every channel raster and/or have a synchronization block within a minimum carrier bandwidth of 3/5 MHz. In another option, fine granular secondary rasters can be configured in such frequency carrier within a frequency band or frequency band where minimum carriers are present such as n106, n110 where only 3 MHz channel bandwidth is present.

6G synchronization rasters are distinct from 5G synchronization rasters. In one example, the synchronization raster can be defined as: Fsych=1200*N+50*M+offset, where the offset may be 300, 400, 500, 600, 700, 800, or 900, and M=1,3, or 5. In another example, Fsych=600*N+50M, where M={7, . . . 23}. In one implementation, Fsych=1200*N+150*M, where M={3, 4, 5, 6, 7}.

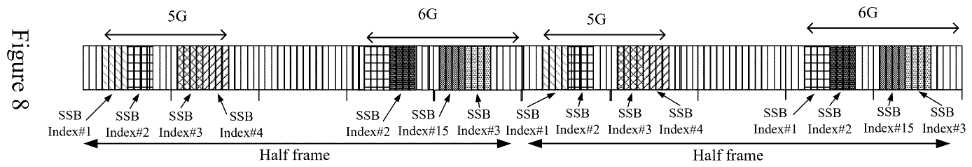

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904). For example, the processor 902 may support wireless communication at the UE 900 in accordance with examples as disclosed herein. The UE 900 may be configured to or operable to support a means for transmitting a signal over one or more radio frequencies, where the signal is generated based at least in part on a synchronization raster frequency offset of a first RAT relative to a second RAT.

Additionally, the UE 900 may be configured to support any one or combination of where synchronization rasters of the first RAT may interleave with synchronization rasters of the second RAT, and synchronization rasters of the first RAT align with channel rasters. The synchronization rasters of the first RAT may be centered with SSBs inside channel bandwidths. The channel bandwidths may be spaced based at least in part on a 100 kilohertz (kHz) spacing and include a valid synchronization raster satisfying a predetermined condition. A frequency carrier center of the first RAT may be less than or equal to 0.45 megahertz (MHz) from a frequency of the synchronization rasters of the second RAT. The UE or NE may detect the first RAT by coarsely tuning a RF to match a RF of the first RAT. The synchronization raster frequency offset may include one or more of a large raster shift, a small raster shift, or a constant offset. The constant offset may include a predefined offset from the first RAT and the synchronization rasters of the first RAT and the second RAT may be interlaced. The large raster shift and the small raster shift may be multipliers from the second RAT.

Additionally, or alternatively, the UE 900 may support at least one memory (e.g., the memory 904) and at least one processor (e.g., the processor 902) coupled with the at least one memory and configured to cause the UE to transmit a signal over one or more radio frequencies, where the signal is generated based at least in part on a synchronization raster frequency offset of a first RAT relative to a second RAT. Or the UE may receive a signal over one or more radio frequencies and process the signal to identify a RAT associated with the signal, where the RAT is identified based at least in part on a synchronization raster frequency offset of a first RAT relative to a second RAT.

Additionally, the UE 900 may be configured to support any one or combination of where the UE may detect the first RAT by coarsely tuning a RF to match a RF of the first RAT. The synchronization rasters of the first RAT may interleave with synchronization rasters of the second RAT, and synchronization rasters of the first RAT may align with channel rasters. The synchronization rasters of the first RAT may be centered SSBs inside channel bandwidths. The channel bandwidths may be spaced based at least in part on a 100 kilohertz (kHz) spacing and include a valid synchronization raster satisfying a predetermined condition. A frequency carrier center of the first RAT may be less than or equal to 0.45 megahertz (MHz) from a frequency of the synchronization rasters of the second RAT. The synchronization raster frequency offset may include one or more of a large raster shift, a small raster shift, or a constant offset. The constant offset may include a predefined offset from the first RAT and the synchronization rasters of the first RAT and the second RAT are interlaced. The large raster shift and the small raster shift may be multipliers from the second RAT.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

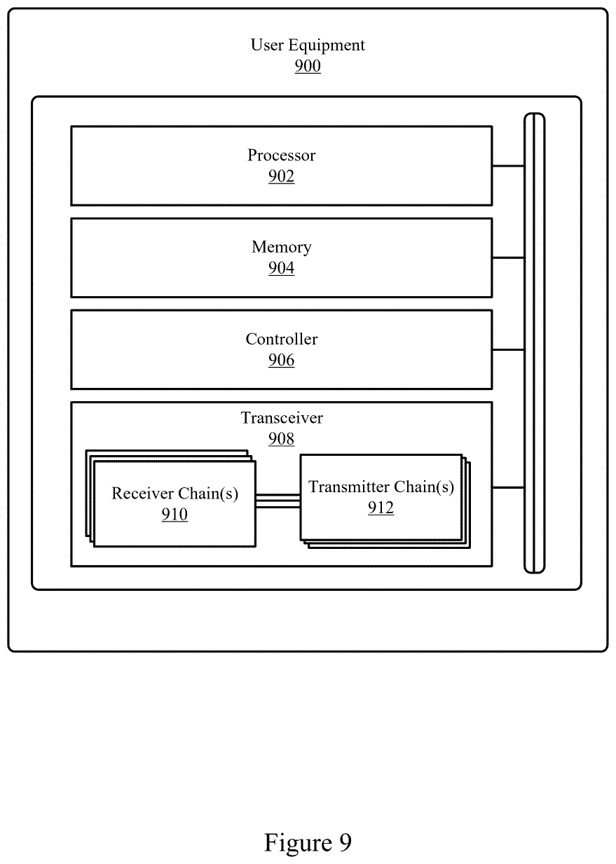

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory addresses of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, ALUs 1006, and other functional units of the processor 1000.

The memory 1004 may include one or more caches (e.g., memory local to or included in the processor 1000 or other memory, such as RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, and the controller 1002, and may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 may be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to receive a signal over one or more radio frequencies, and process the signal to identify a RAT associated with the signal, where the RAT is identified based at least in part on a synchronization raster frequency offset of a first RAT relative to a second RA.

Additionally, the processor 1000 may be configured to or operable to support any one or combination of where the processor may detect the first RAT by coarsely tuning a RF to match a RF of the first RAT. The synchronization rasters of the first RAT may interleave with synchronization rasters of the second RAT, and synchronization rasters of the first RAT may align with channel rasters. The synchronization rasters of the first RAT may be centered with SSBs inside channel bandwidths. The channel bandwidths may be spaced based at least in part on a 100 kilohertz (kHz) spacing, and include a valid synchronization raster satisfying a predetermined condition. A frequency carrier center of the first RAT may be less than or equal to 0.45 megahertz (MHz) from a frequency of the synchronization rasters of the second RAT. The synchronization raster frequency offset may include one or more of a large raster shift, a small raster shift, or a constant offset. The constant offset may include a predefined offset from the first RAT and the synchronization rasters of the first RAT and the second RAT are interlaced. The large raster shift and the small raster shift may be multipliers from the second RAT.

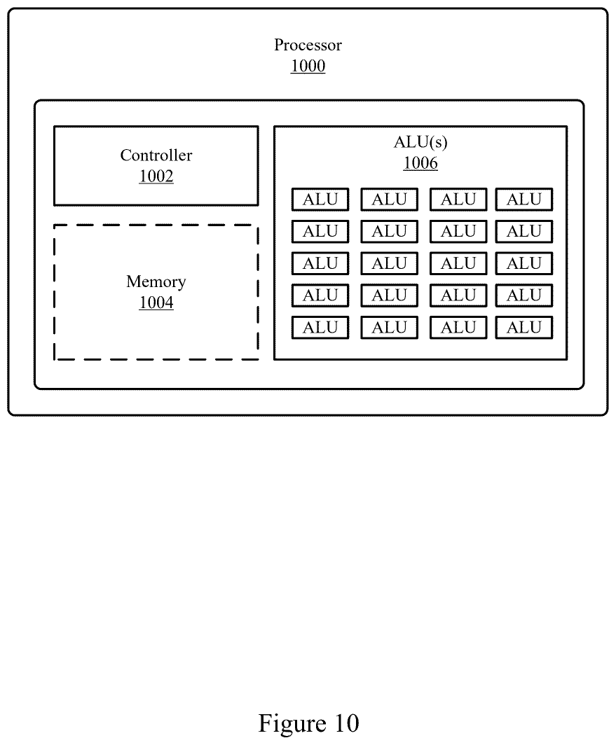

FIG. 11 illustrates an example of an NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein. The NE 1100 may be configured to or operable to support a means for transmitting a signal over one or more radio frequencies, wherein the signal is generated based at least in part on a synchronization raster frequency offset of a first RAT relative to a second RAT.

Additionally, the NE 1100 may be configured to or operable to support any one or combination of where the NE may detect the first RAT by coarsely tuning a RF to match a RF of the first RAT. The synchronization rasters of the first RAT may interleave with synchronization rasters of the second RAT, and synchronization rasters of the first RAT may align with channel rasters. The synchronization rasters of the first RAT may be centered with SSBs inside channel bandwidths. The channel bandwidths may be spaced based at least in part on a 100 kilohertz (kHz) spacing, and include a valid synchronization raster satisfying a predetermined condition. A frequency carrier center of the first RAT may be less than or equal to 0.45 megahertz (MHz) from a frequency of the synchronization rasters of the second RAT. The synchronization raster frequency offset may include one or more of a large raster shift, a small raster shift, or a constant offset. The constant offset may include a predefined offset from the first RAT and the synchronization rasters of the first RAT and the second RAT are interlaced. The large raster shift and the small raster shift may be multipliers from the second RAT.

Additionally, or alternatively, the NE 1100 may support at least one memory (e.g., the memory 1104) and at least one processor (e.g., the processor 1102) coupled with the at least one memory and configured to cause the NE to transmit a signal over one or more radio frequencies, wherein the signal is generated based at least in part on a synchronization raster frequency offset of a first RAT relative to a second RAT.

Additionally, the NE 1100 may be configured to support any one or combination of where the NE may detect the first RAT by coarsely tuning a RF to match a RF of the first RAT. The synchronization rasters of the first RAT may interleave with synchronization rasters of the second RAT, and synchronization rasters of the first RAT may align with channel rasters. The synchronization rasters of the first RAT may be centered with SSBs inside channel bandwidths. The channel bandwidths may be spaced based at least in part on a 100 kilohertz (kHz) spacing, and include a valid synchronization raster satisfying a predetermined condition. A frequency carrier center of the first RAT may be less than or equal to 0.45 megahertz (MHz) from a frequency of the synchronization rasters of the second RAT. The synchronization raster frequency offset may include one or more of a large raster shift, a small raster shift, or a constant offset. The constant offset may include a predefined offset from the first RAT and the synchronization rasters of the first RAT and the second RAT are interlaced. The large raster shift and the small raster shift may be multipliers from the second RAT.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

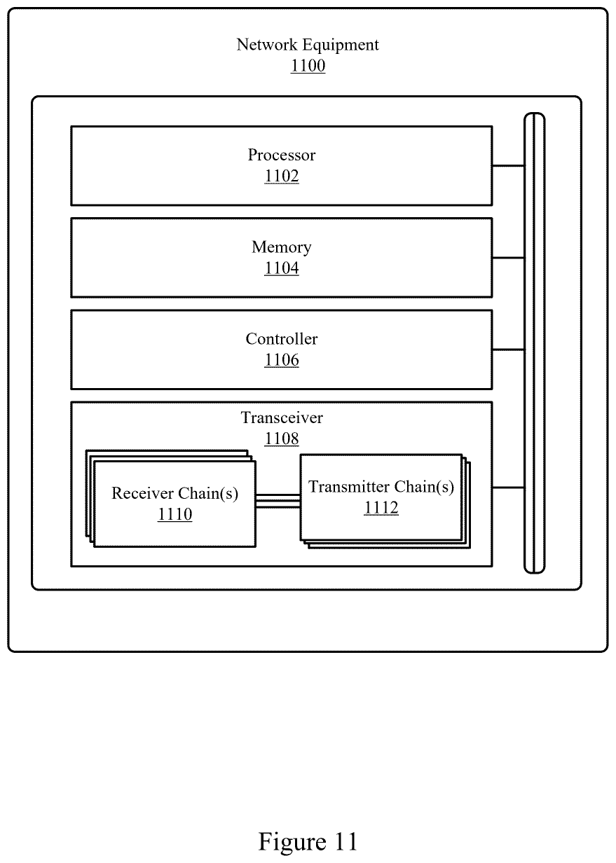

FIG. 12 illustrates a flowchart of a method 1200 in accordance with aspects of the present disclosure. The operations of the method may be implemented by a NE and/or a UE as described herein. In some implementations, the NE and/or the UE may execute a set of instructions to control the function elements of the NE and/or the UE to perform the described functions. It should be noted that the method described herein describes a possible implementation, and that the operations and the steps may be rearranged or otherwise modified and that other implementations are possible.

At 1202, the method may include generating a signal based at least in part on a synchronization raster frequency offset of a first RAT relative to a second RAT. The operations of 1202 may be performed in accordance with examples as described herein. In some implementations, aspects of the operations of 1204 may be performed by an NE as described with reference to FIG. 11 and/or a UE as described with reference to FIG. 9.

At 1204, the method may include transmitting the signal over one or more radio frequencies. The operations of 1202 may be performed in accordance with examples as described herein. In some implementations, aspects of the operations of 1202 may be performed by an NE as described with reference to FIG. 11 and/or a UE as described with reference to FIG. 9.

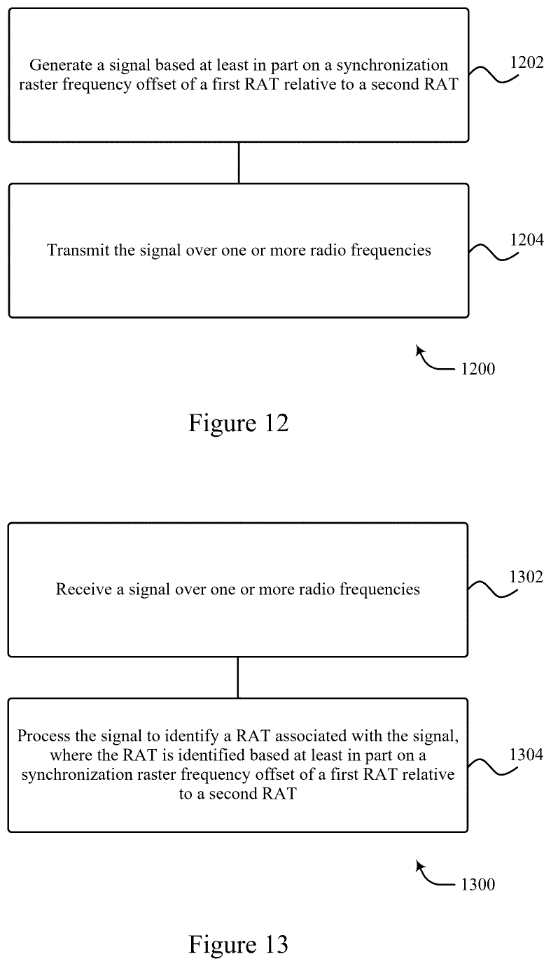

FIG. 13 illustrates a flowchart of a method 1300 in accordance with aspects of the present disclosure. The operations of the method may be implemented by a NE and/or a UE as described herein. In some implementations, the NE and/or the UE may execute a set of instructions to control the function elements of the NE and/or the UE to perform the described functions. It should be noted that the method described herein describes a possible implementation, and that the operations and the steps may be rearranged or otherwise modified and that other implementations are possible.

At 1302, the method may include receiving a signal over one or more radio frequencies. The operations of 1302 may be performed in accordance with examples as described herein. In some implementations, aspects of the operations of 1302 may be performed by an NE as described with reference to FIG. 11.

At 1304, the method may include processing the signal to identify a RAT associated with the signal, where the RAT is identified based at least in part on a synchronization raster frequency offset of a first RAT relative to a second RAT. The operations of 1304 may be performed in accordance with examples as described herein. In some implementations, aspects of the operations of 1304 may be performed by an NE as described with reference to FIG. 11.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
at least one memory; and
at least one processor coupled with the at least one memory and operable to cause the apparatus to:
transmit a signal over one or more radio frequencies, wherein the signal is generated based at least in part on a synchronization raster frequency offset of a first radio access technology (RAT) relative to a second RAT.

2. The apparatus of claim 1, wherein synchronization rasters of the first RAT interleaves with synchronization rasters of the second RAT, and synchronization rasters of the first RAT align with channel rasters.

3. The apparatus of claim 1, wherein the synchronization rasters of the first RAT are centered with synchronized signal blocks (SSBs) inside channel bandwidths.

4. The apparatus of claim 3, wherein the channel bandwidths are spaced based at least in part on a 100 kilohertz (kHz) spacing, and comprise a valid synchronization raster satisfying a predetermined condition.

5. The apparatus of claim 1, wherein a frequency carrier center of the first RAT is less than or equal to 0.45 megahertz (MHz) from a frequency of the synchronization rasters of the second RAT.

6. The apparatus of claim 1, wherein the at least one processor is operable to cause the apparatus to:
detect the first RAT by coarsely tuning a radio frequency (RF) to match a RF of the first RAT.

7. The apparatus of claim 1, wherein the synchronization raster frequency offset comprises one or more of a large raster shift, a small raster shift, or a constant offset.

8. The apparatus of claim 7, wherein the constant offset comprises a predefined offset from the first RAT and the synchronization rasters of the first RAT and the second RAT are interlaced.

9. The apparatus of claim 7, wherein the large raster shift and the small raster shift are multipliers from the second RAT.

10. An apparatus for wireless communication, comprising:
at least one memory; and
at least one processor coupled with the at least one memory and operable to cause the apparatus to:
receive a signal over one or more radio frequencies; and
process the signal to identify a radio access technology (RAT) associated with the signal, wherein the RAT is identified based at least in part on a synchronization raster frequency offset of a first RAT relative to a second RAT.

11. The apparatus of claim 10, wherein synchronization rasters of the first RAT interleaves with synchronization rasters of the second RAT, and synchronization rasters of the first RAT align with channel rasters.

12. The apparatus of claim 10, wherein the synchronization rasters of the first RAT are centered with synchronized signal blocks (SSBs) inside channel bandwidths.

13. The apparatus of claim 12, wherein the channel bandwidths are spaced based at least in part on a 100 kilohertz (kHz) spacing, and comprise a valid synchronization raster satisfying a predetermined condition.

14. The apparatus of claim 10, wherein a frequency carrier center of the first RAT is less than or equal to 0.45 megahertz (MHz) from a frequency of the synchronization rasters of the second RAT.

15. The apparatus of claim 10, wherein the at least one processor is operable to cause the apparatus to:
detect the first RAT by coarsely tuning a radio frequency (RF) to match a RF of the first RAT.

16. The apparatus of claim 10, wherein the synchronization raster frequency offset comprises one or more of a large raster shift, a small raster shift, or a constant offset.

17. The apparatus of claim 16, wherein the constant offset comprises a predefined offset from the first RAT and the synchronization rasters of the first RAT and the second RAT are interlaced.

18. The apparatus of claim 16, wherein the large raster shift and the small raster shift are multipliers from the second RAT.

19. A method performed by an apparatus for wireless communication, the method comprising:
transmitting a signal over one or more radio frequencies, wherein the signal is generated based at least in part on a synchronization raster frequency offset of a first radio access technology (RAT) relative to a second RAT.

20. A method performed by an apparatus for wireless communication, the method comprising:
receiving a signal over one or more radio frequencies; and
processing the signal to identify a radio access technology (RAT) associated with the signal, wherein the RAT is identified based at least in part on a synchronization raster frequency offset of a first RAT relative to a second RAT.
